(19) United States
(12) Patent Application Publication
(10) Pub. No.: US 2006/0086048 A1
(43) Pub. Date: Apr. 27, 2006

(54) Foam dentifrice composition and method

(76) Inventor: Michael G. Romley, Phoenix, AZ (US)

Correspondence Address: David G. Rosenbaum;ROSENBAUM & ASSOCIATES, P.C., Suite #380, 650 Dundee Road, Northbrook, IL, 60062, US

(21) Appl. No.: 10/973,587

(22) Filed: Oct. 26, 2004

(51) Int. Cl. E05F 5/12

(52) U.S. Cl. 49/103

(57) ABSTRACT

A dentifrice composition having a low viscosity and is capable of being dispensed and used as a foam in a propellant-less dispensing system.

### BACKGROUND OF THE INVENTION

The present invention relates generally to a dentifrice composition which is dispensed as a foam for use as a foam. More specifically, the inventive dentifrice composition is adapted to be dispensed from a suitable dispenser as a non-abrasive foam. The dispensed dentifrice may foam as a result of aeration of the composition by a propellant co-dispensed from the dispenser, may foam as a result of admixture of a gaseous species, such as air, within the dispenser during dispensing, or may foam as a result of a reaction between one or more components in the dentifrice composition as it contacts ambient air.

The inventive foam dentifrice composition consists generally of a surfactant, a disinfectant or antibacterial agent and at least one flavoring agent. A colorant may, optionally, be included in the composition. Each of the components of the composition may be either synthetic or chemically-derived or naturally accruing extracts, as will be described hereinafter. Preferably, the inventive foam dentifrice cleans teeth without employing abrasive particles such as silica.

Conventional dentifrice compositions are either in a liquid, paste or powder form, which foam during use in a user's mouth and employ abrasive particles to clean a user's teeth and gums. The vast majority of dentifrice compositions marketed today include a wide variety of synthetic chemical compounds, including anionic, non-ionic or amphoteric surfactants to enhance foaming and cleaning, humectants to prevent hardening of the paste by retaining moisture in the composition, peroxides for antisepsis, and other included compounds.

Most toothpaste or dentifrice compositions currently marketed and sold contain both active and inactive ingredients. The active ingredients include fluoride, antibacterial agents, desensitizing agents, anti-tartar agents, sodium bicarbonate, enzymes to enhance saliva's natural antibacterial activity, and xylitol. Inactive ingredients typically found in conventional toothpaste compositions include water, detergents, binding agents, humectants, flavoring, sweetening, and coloring agents, preservatives and abrasives.

Fluoride, such as sodium fluoride, may be included in the composition to promote remineralization. A surfactant is typically employed as a detergent foaming agent. Sodium lauryl sulfate, ammonium lauryl sulfate, or lauryl sarcosinate are typically employed. Alantoin is frequently employed an anti-irritant to counteract the irritating properties of the surfactants. A sequestering agent, such as tetrasodium pyrophosphate (TSPP) may be used to sequester calcium and magnesium from the saliva, and prevent redeposit as tartar. Polymers such as the acrylic PVM/MA copolymer are added often to prevent bacteria from breaking down pyrophosphates. Other long polymers used are polyethylene glycol (PEG) in various weights (i.e. PEG-6, PEG-8, PEG-40, etc.), and polypropylene glycol (PPG).

Polymers such as the acrylic PVM/MA copolymer are often added to prevent bacteria from breaking down pyrophosphates. Other long polymers used are polyethylene glycol (PEG) in various weights (i.e. PEG-6, PEG-8, PEG-40, etc.), and polypropylene glycol (PPG).

Sodium bicarbonate (baking soda) is frequently added to dentifrice compositions to enhance taste and mouth feel. Sodium bicarbonate reacts with acids to release carbon dioxide gas, adding to the foam produced by brushing.

Sodium carbonate peroxide is added to “peroxide” toothpastes as a whitener. In the mouth, it undergoes a degradation reaction to produce sodium carbonate and hydrogen peroxide. The hydrogen peroxide bleaches the teeth, and acts as an antiseptic.

Sweeteners such as sodium saccharin are often added for enhance taste. Other flavors are usually strong essential oils in the mint family.

Triclosan, an anti-bacterial agent, is frequently used as an antimicrobial to aid in preventing plaque formation.

Various gums are used to thicken the paste, but also to retain moisture, so the toothpaste does not dry out if the top is not replaced. Finally, titanium dioxide is oftentimes used to make the paste opaque and white.

Each of the conventional dentifrices relies upon interaction with saliva to initiate foaming. Attempts to formulate foam dentifrice compositions have, heretofore, been impracticable in that they require a very high soap concentration, i.e., greater than 35% by weight (U.S. Pat. No. 4,393,042) or require an anionic surfactant, such as sodium cocomonoglyceride sulfonate, sodium lauryl sarcosinate or sodium lauryl sulfate, as a foaming agent in a composition with glycerin and hydrogen peroxide which is delivered using propellant-less dispenser (U.S. Pat. No. 5,665,332).

### SUMMARY OF THE INVENTION

It is, therefore, a principal objective of the present invention to provide a toothpaste dentifrice which is dispensed as a foam, capable of being carried on a toothbrush from the dispenser to the mouth as foam and used within the mouth as a foam.

It is a more specific objective of the present invention to provide a foam dentifrice which is dispensable from either a propellant-based dispenser or from a propellant-less dispenser.

It is yet another objective of the present invention to provide a foam toothpaste which utilizes a non-peroxide antiseptic agent.

These and other objectives, features and advantages of the present invention will become more apparent to those of ordinary skill in the art from the following more detailed description of the present invention with reference to its preferred embodiments.

### DETAILED DESCRIPTION OF THE PREFERRED EMBODIMENTS

In accordance with the most preferred embodiment of the present invention, there is provided an aqueous suspension comprising purified water, colloidal silver, xylitol, stevia, glycerin, aloe vera, xanthan gum, spearmint oil, peppermint oil, methol and cocomide diethanolamine (DEA), wherein the aqueous suspension has a viscosity of about 1.2 centipoises which is sufficient to cause the suspension to foam as it is dispensed from a pump-type propellant-less dispenser. Colloidal silver acts as an antibacterial and disinfectant, the xylitol functions to remove plaque and also as a sweetener, stevia is also a sweetener and antibacterial, in addition to its sweetener effect, glycerin acts as a moisturizer and lubricant as does the aloe vera. Xanthan gum increases viscosity and acts as a lubricant. Spearmint and peppermint oils are flavorings and aid in a fresh feeling in the mouth as does the menthol. Finally, the cocomide DEA functions as a foaming agent.

The composition of the present invention preferably has as a major fraction, naturally occurring compounds and a minor fraction synthetic compounds. In accordance with preferred embodiments of the present invention, various constituent compounds may be employed in making the inventive foaming oral care composition. The following is a non-limiting list, by class of constituents, which may, optionally be included in the present invention.

Surfactants

Surfactants are surface-active agents included in compositions to enhance foaming and cleaning effect of a composition, and may be included in the present invention for that purpose. Preferred surfactants are either non-ionic or amphoteric. A preferred non-ionic surfactant is cocomide diethanolamine (cocomide DEA). Alternative non-ionic surfactants useful with the present invention include: substituted polyethylene glycol ethers selected from PEG-32 glyceryl stearate and PEG-40 sorbitan di-isostearate.

Non-ionic or amphoteric surfactants may be present in the composition from about 0.00001% to about 35% by weight of the composition, but preferably comprises between about 4.0 to 8.0% by weight of the composition.

Alternative surfactants suitable for use with the present invention include, anionic surfactants such as sodium alkyl sulphate. By “alkyl sulphate” it is meant herein the water-soluble salts of alkyl sulphates having from 8 to 20 carbon atoms in the alkyl radical, including sodium lauryl sulphate. Further anionic surfactants useful herein include the potasium alkyl sulphates having from 8 to 20 carbon atoms in the alkyl radical (e.g., sodium alkyl sulphate), sulphoacetates, alkyl glyceryl sulphonates and the sarcosinates. Non-limiting examples of the anionic surfactants of this type which are suitable for the present invention are sodium decyl sulphate, sodium lauryl sulphosuccinate, sodium lauryl sulphate and sodium lauroyl sarcosinate. Anionic surfactants can be used at levels as low as about 0.0001% or up to about 25% by weight of the composition. Highly preferred levels of anionic surfactant, and especially of sodium alkyl sulphate, are from about 0.7 to about 3%, preferably from about 1% to about 2% by weight.

An alternative foaming and cleaning agent useful with the present invention includes cocomidopropyl betaine which is an amphoteric surfactant. Amphoteric surfactants useful in the present invention can be broadly described as derivatives of aliphatic secondary and tertiary amines in which the aliphatic radical can be a straight chain or branched and wherein one of the aliphatic substituent groups contains from about 8 to about 18 carbon atoms and one contains an anionic water-solubilising group e.g. carboxylate, sulfonate, sulphate, phosphate or phosphonate. Other suitable amphoteric surfactants are betaines, specifically cocamidopropyl betaine. Mixtures of amphoteric surfactants or mixtures of amphoteric and anionic surfactants may also be employed.

Aqueous Carrier

The composition of the present invention is water-based and is therefore aqueous. The carrier comprises water and may, optionally, include one or more humectants to match the refractive index of the carrier to that of particulates in the composition used to enhance dental cleaning, such as silica or pyrophosphate. Water used in the preparation of these compositions should preferably be of low ion content and free of organic impurities. The “total water content” of the composition, as used herein, includes the free water which is added plus the water which is introduced with other materials, such as with sorbitol, silica, color solutions, surfactant solutions, or water of crystallization of materials such as tetrasodium pyrophosphate decahydrate. The total water content of the compositions of present invention is preferably less than about 80% by weight of the composition and is preferably within the range of between about 50 to 74% by weight of the composition.

Humectants are highly desirable components of the liquid carrier. The humectant serves to keep dentifrice compositions from hardening upon exposure to air and certain humectants can also impart desirable sweetness of flavor to dentifrice compositions. Furthermore, the humectants are normally essential for balancing the refractive index of the aqueous liquid carrier since water has a relatively low RI of 1.33. Suitable humectants for use in the invention include xylitol, glycerin, sorbitol (typically used as a 70% aqueous solution), polyethylene glycols of MW 1500 or less, propylene glycol and combination thereof. The most preferred humectant is xylitol. If xylitol is used then, for best clarity of the composition, it is also preferred to employ a secondary humectant selected from glycerin, propylene glycol, polyethylene glycols of MW less than 1500 and mixtures thereof. In accordance with the present invention, glycerin and xylitol are employed in the composition, with a total humectant concentration being between about 5% by weight to about 50% by weight of the aqueous composition. In addition to its humectant properties, xylitol may provide an additional therapeutic effect, such as an antibacterial or anticaries effect. Suitable levels of xylitol in the inventive composition dentifrice of the present invention are from about 0.001% to about 25%.

Other Components

The dentifrice compositions of the present invention can include a wide variety of optional components provided they are employed at levels which are not substantially detrimental to the production or stability of the foam. A non-exhaustive list includes:

Essential Oils

The dentifrice of the present invention preferably comprises an essential oil which acts to flavor or perfume the composition. The components of the essential oil may be in the form of an oil, liquid, semi-solid, solid, or powder and may be of a natural and/or synthetic flavor origin. The term “flavor” according to the present invention means any essence, either natural or synthetic, or active agent (such as coolant agents), included in a composition to provide a palatable taste profile or physiological effect upon use. The flavor oil generally consists of a mixture of flavor components from the group consisting of peppermint, spearmint, cinnamon, spice, wintergreen, fruit, citrus, herbal, medicinal, and common food flavors (i.e. chocolate) and mixtures thereof. Illustrative, but nonlimiting examples of such components include, peppermint oils such as Mentha pipevita and Mentha avvensis; spearmint oils such as Mentha cavdiaca and Mentha spicata; hydrocarbons such as limonene, caryophyllene, myrcene, and humulene; alcohols such as menthol, linalool, 3-decanol, and pinocarveol; ketones such as piperitone, menthone, spicatone, and 1-carvone; aldehydes such as acetaldehyde, 3-hexanal, or n-octanal; oxides such as menthofuran, pepertione oxide; acids such as acetic and ocenoic; and sulphides such as dimethyl sulphide. Components also include esters such as menthyl acetate, benzyl isobutyrate, and 3-octyl acetate. The esters are stable in compositions having a pH of about 7 or lower. The components can also include essential oils such as sage oil, parsley oil, mardoram oil, cassia oil, clove bud oil, cinnamon oil, eucalyptus oil, anise oil, and mixtures thereof. The flavor components can also include chemicals such as cinnamic aldehyde, eugenol, ionone, 60 anethole, eucalyptol, methyl salicylate, oxanone, alpha-irisone, vanillin, ethyl vanillin, heliotropine, propenyl guaethol, vanilla extracts, veratraldehyde, 4-cis-heptenal, diacetyl, butyl lactate, ethyl lactate, methyl-para-tert-butyl phenyl acetate, gamma and delta hexalactone and 65 heptalactone, benzodihydropyrone, butter starter distillate, delta tetradecalactone, butyraldehyde, and mixtures thereof. Preferred flavoring oils are peppermint oils, spearmint oils, menthol, anethole, methyl salicylate, cinnamon oils, clove bud oils, oxanone, and mixtures thereof. Flavor components are described in more detail in Fenaroli's Handbook of Flavour Ingredients, Third Edition, Volumes 1 & 2, CRC Press, Inc. (1995), and Steffen Arctander's Perfume and Flavour Chemicals, Volumes 1 & 2, (1969). A physiological cooling agent may also be incorporated into the flavour oil. The coolant can be any of a wide variety of materials. Included among such materials are carboxamides, menthol, acetals, ketals, diols, and mixtures thereof. Preferred coolants in the present compositions are the paramenthane carboxyamide agents such as N-ethyl-p-menthan-3-carboxamide, (known commercially as “WS-3”) and mixtures thereof and methanone glycerine acetal (known commercially as “MGA”). Further disclosure of coolants suitable for the present invention are discussed in WO97/106695, incorporated by reference herein. The flavor oil is used in the present composition at levels of from about 0.1% to about 10.0%, preferably from about 0.5% to about 5.0%, and most preferably from about 0.1% to about 2.0%, by weight of the composition.

Herbal Additives

Alternative herbal additives which may be used to impart flavoring or perfume include, without limitation, comfry root, calendula, rose hips, pomegranate, Quillaja Saponaria Extract (Panama Wood), Matricaria (Chamomilla Recutita) Extract (Chamomile), Rosmarinus Officinalis (Rosemary) Extract (Rosemary Leaves), Salvia Officinalis (Sage) Extract (Sage Leaves), Thymus Vulgaris (Thyme) Extract (Thyme Leaves), Oryza Sativa (Rice) Bran Oil (Rice Bran), Serenoa Serrulata Fruit Extract, Camellia Sinensis Leaf Extract, or essential oils, such as, for example, Lavender (Lavendula angustifolia), Patchouli (Pogostemon cablin), Peppermint (Mentha piperita), Rose (Rosa damascena), Spearmint (Mentha spicata), or Ylang-Ylang (Cananga odorata).

Fluoride Ion Source

A highly preferred component of the dentifrice of the present invention is a fluoride source capable of providing free fluoride ions. Preferred soluble fluoride ion sources include sodium fluoride, stannous fluoride, indium fluoride, and sodium monofluorophosphate. Sodium fluoride is the most preferred fluoride ion source. Norris et al., U.S. Pat. No. 2,946,725, issued Jul. 26, 1960, and Widder et al., U.S. Pat. No. 3,678,154 issued Jul. 18, 1972, disclose such fluoride ion sources as well as others. The present compositions generally contain a fluoride source capable of providing from about 50 ppm to about 3500 ppm, and preferably from about 200 ppm to about 2500 ppm, more preferably from 500 ppm to 2000 ppm of free fluoride ions.

Coloring and Sweetening Agents

Coloring and sweetening agents may also be added to enhance the appeal and usability of the dentifrice composition. The coloring agent may be in the form of an aqueous solution, preferably 1% coloring agent in a solution of water. Color solutions generally comprise from about 0.01% to about 5%, by weight of the composition. An insoluble coloring agent such as a colored speckle may also be used, provided it does not significantly obscure the overall, visually clear appearance of the composition. Pigmented silicas can be employed for this purpose, typically at a level of from 0.05 to 0.2%.

Suitable sweetening agents include stevia, sodium saccharin, dextrose, sucrose, chlorinated sucrose, lactose, maltose, aspartame, sodium cyclamate, D-tryptophan, dihydrochalcones, xylitol, and mixtures thereof. The most preferred sweetening agent is stevia, which is employed between 0.001% to about 20% by weight, preferably about 0.003% by weight. Other, less “sweet” sweetening agents are generally used in dentifrice compositions at levels of from about 0.005% to about 5%, by weight of the composition.

Antimicrobial Agents

The compositions of the present invention may also include antimicrobial agents. Included among such agents are water insoluble non-cationic antimicrobial agents such as halogenated diphenyl ethers, phenolic compounds including phenol and its horologes, mono and poly-alkyl and aromatic halophenols, resorcinol and its derivatives, bisphenolic compounds and halogenated salicylanilides, benzoic esters, and halogenated carbanilides. The water soluble antimicrobials include quaternary ammonium salts and bis-biguanide salts, among others. Triclosan monophosphate is an additional water soluble antimicrobial agent. The quaternary ammonium agents include those in which one or two of the substitutes on the quaternary nitrogen has a carbon chain 65 length (typically alkyl group) from about 8 to about 20, typically from about 10 to about 18 carbon atoms while the remaining substitutes (typically alkyl or benzyl group) have so a lower number of carbon atoms, such as from about 1 to e about 7 carbon atoms, typically methyl or ethyl groups. Dodecyl trimethyl ammonium bromide, tetradecylpyridinium chloride, domiphen bromide, N-tetradecyl-4-ethyl pyridinium chloride, dodecyl dimethyl (2-phenoxyethyl) ammonium bromide, benzyl dimethylstearyl ammonium chloride, cetyl pyridinium chloride, quaternized 5-amino-1,3-bis(2-ethyl-hexyl)-5-methyl hexa hydropyrimidine, benzalkonium chloride, benzethonium chloride and methyl benzethonium chloride are exemplary of typical quaternary ammonium antibacterial agents. Preferably, when an anionic surfactant is used in the dentifrice of the present invention, a quaternary ammonium agent is not employed.

Disinfectant

The dentifrice of the present invention preferably includes a non-peroxide disinfectant. Non-peroxide disinfectants useful with the present invention include colloidal silver, and honey glucose oxidase obtained from jelly bush (Leptospermum sp.) or manuka honey (Leptospermum scoparium). The present invention may also include an alkali metal antimicrobials such as copper bisglycinate, zinc citrate, and bicarbonate salt. Alkali metal bicarbonate salts are soluble in zinc lactate may also be included. Also useful are enzymes, water and, unless stabilised, tend to release carbon dioxide including endoglycosidase, papain, dextranase, mutanase, in an aqueous system. Sodium bicarbonate, also known as baking soda, is the preferred alkali metal bicarbonate salt and mixtures thereof. Such agents are disclosed in U.S. Pat. No. 2,946,725 and U.S. Pat. No. 4,051,234 incorporated herein by reference. The present composition may contain up to 10%, preferably from about 0.05% to about 5%, more preferably from about 0.1% to about 1%. Alternative antimicrobial agents include chlorhexidine, triclosan, triclosan monophosphate, and flavor oils such as thymol. Triclosan is particularly preferred. Triclosan and other agents of this type are disclosed in U.S. Pat. No. 5,015,466, issued, and U.S. Pat. No. 4,894,220 incorporated herein by reference. Non-peroxide disinfects are preferably employed between about 0.1 ppm to about 20 ppm of the composition, most preferably about 5 ppm.

While not preferred, peroxide disinfectants may, alternatively, also be used. The peroxide source is suitably selected from hydrogen peroxide, calcium peroxide, urea peroxide, and mixtures thereof. The preferred peroxide source is calcium peroxide. The following amounts represent the amount of peroxide raw material, although the peroxide source may contain ingredients other than the peroxide raw material. The present composition may contain from about 0.01% to about 10%, preferably from about 0.1% to about 5%, more preferably from about 0.2% to about 3%, and most preferably from about 0.3% to about 0.8% of a peroxide source, by weight of the composition.

Thickening agents may be employed to increase the viscosity of the inventive composition. Conventional thickening agents such as carrageenan, hydroxyethyl cellulose, and water soluble salts comprising short chain, saturated, hydrocarbon alcohol, of cellulose ethers such as sodium carboxymethylcellulose wherein the short chain alcohol is selected from ethanol, and sodium carboxymethyl hydroxyethyl cellulose or gums, such as gum karaya, xanthan gum, gum Arabic or gum tragacanth may be employed. A most preferred thickening agent is xanthan gum and is employed at between about 0.0001% to about 0.001% by weight of the aqueous composition, such that the composition does not exceed about 1.6 centipoises viscosity.

Viscosity of the inventive composition is important to permit dispensing as a foam from a propellantless dispenser. Thus, it has been found particularly desirable to formulate the inventive composition such that it has a viscosity between about 1.1 and 1.6 centipoises.

Preferred compositions may be found in Tables 1-10 below, in which all quantities, unless otherwise stated, are expressed in milligrams based upon 100 ml of purified water:

TABLE 1

| Component | Preferred Concentration (mg) | |
|---|---|---|
| Active Manuka Honey | 20 | ppm |
| Xylitol | 10,000 | |
| Glycerin | 20,000 | |
| Aloe Vera | 25,000 | |
| Xanthan Gum | 1,000 | |
| Spearmint Oil | 30,000 | |
| Menthol | 5,000 | |
| Cocomide DEA | 1,000 | |

TABLE 2

| Component | Preferred Concentration (mg) | |
|---|---|---|
| Colloidal Silver | 1 | ppm |
| Xylitol | 50,000 | |
| Stevia | 5 | |
| Glycerin | 100 | |
| Aloe Vera | 25,000 | |
| Xanthan Gum | 500 | |
| Spearmint Oil | 1000 | |
| Peppermint Oil | 5000 | |
| Menthol | 5 | |
| Cocomide DEA | 250 | |

TABLE 3

| Component | Preferred Concentration (mg) | |
|---|---|---|
| Colloidal Silver | 5 | ppm |
| Xylitol | 5,000 | |
| Stevia | 30 | |
| Glycerin | 1,000 | |
| Aloe Vera | 5,000 | |
| Xanthan Gum | 100 | |
| Spearmint Oil | 4,000 | |
| Peppermint Oil | 1,000 | |
| Menthol | 100 | |
| Cocomide DEA | 10,000 | |

TABLE 4

| Component | Preferred Concentration (mg) | |
|---|---|---|
| Colloidal Silver | 5 | ppm |
| Sorbitol | 25,000 | |
| Stevia | 5 | |
| Glycerin | 500 | |
| Aloe Vera | 2,500 | |
| Xanthan Gum | 100 | |
| Spearmint Oil | 4,000 | |
| Peppermint Oil | 1,000 | |
| Chamomile Extract | 500 | |
| Menthol | 100 | |
| Sodium Lauryl Sulfate | 5,000 | |

TABLE 5

| Component | Preferred Concentration (mg) | |
|---|---|---|
| Colloidal Silver | 5 | ppm |
| Sorbitol | 5,000 | |
| Stevia | 30 | |
| Glycerin | 1,000 | |
| Aloe Vera | 5,000 | |
| Gum Karaya | 100 | |
| Spearmint Oil | 4,000 | |
| Peppermint Oil | 1,000 | |
| Menthol | 100 | |
| Sodium Lauryl Sulfate | 2500 | |

TABLE 6

| Component | Preferred Concentration (mg) | |
|---|---|---|
| Triclosan | 3 | ppm |
| Xylitol | 5,000 | |
| Stevia | 10 | |
| Propylene Glycol | 2,500 | |
| Aloe Vera | 5,000 | |
| Gum Tragacanth | 50 | |
| Cinnamon Oil | 4,000 | |
| Menthol | 100 | |
| Ammonium Lauryl Sulfate | 7,500 | |

TABLE 7

| Component | Preferred Concentration (mg) | |
|---|---|---|
| Chlorhexidine | 5 | ppm |
| Xylitol | 5,000 | |
| Stevia | 30 | |
| Glycerin | 1,000 | |
| Aloe Vera | 5,000 | |
| Xanthan Gum | 100 | |
| Spearmint Oil | 4,000 | |
| Peppermint Oil | 1,000 | |
| Sodium Fluoride | 1,000 | |
| Sodium Lauryl Sulfate | 6,000 | |

TABLE 8

| Component | Preferred Concentration (mg) | |
|---|---|---|
| Chlorhexidine | 10 | ppm |
| Xylitol | 10,000 | |
| Stevia | 15 | |
| Propylene Glycol | 2,500 | |
| Aloe Vera | 10,000 | |
| Xanthan Gum | 100 | |
| Thymol | 2,500 | |
| Peppermint Oil | 1,000 | |
| Menthol | 100 | |
| Cocomide DEA | 30,000 | |

TABLE 9

| Component | Preferred Concentration (mg) | |
|---|---|---|
| Honey Glucose oxidase | 25 | ppm |
| Sorbitol | 2,500 | |
| Stevia | 50 | |
| Propylene Glycol | 2,500 | |
| Aloe Vera | 5,000 | |
| Gum Arabic | 50 | |
| Orange Oil | 5,000 | |
| Sodium Fluroide | 1,000 | |
| Menthol | 100 | |
| Cocomide DEA | 15,000 | |

TABLE 10

| Component | Preferred Concentration (mg) | |
|---|---|---|
| Honey Glucose Oxidase | 25 | ppm |
| Xylitol | 10,000 | |
| Stevia | 100 | |
| Glycerin | 1,000 | |
| Aloe Vera | 5,000 | |
| Xanthan Gum | 100 | |
| Eucalyptus Oil | 1,000 | |
| Spearmint Oil | 1,000 | |
| Thymol | 100 | |
| Cocomide DEA | 10,000 | |

The composition or product of the present invention is preferably packaged in a non-aerosol finger-pump with a polyethylene or PVC container, such as that sold by AirSpray International, Pompano Beach, Fla. Non-limiting examples of dispensers suitable for use with the present invention include, for example, include those described in U.S. Pat. Nos. 5,536,629, 5,918,771, 5,429,279, 6,053,364, 6,220,483, each of which is expressly incorporated by reference as teaching suitable dispensing containers for use with the present invention.

It is understood that while the invention has been described in conjunction with the detailed description thereof, that the foregoing description is intended to illustrate and not limit the scope of the invention, which is defined by the scope of the appended claims. Other aspects, advantages, and modifications are within the claims.

What is claimed is:

1. A dentifrice in combination with a non-aerosol foam dispenser comprising a reciprocating manually actuable pump which introduces a foam-producing amount of air into the toothpaste as it is being dispensed from the non-aerosol foam dispenser, the dentifrice further comprising an aqueous, non-abrasive composition having a non-peroxide disinfecting agent, whereby the dentifrice is dispensed from the dispenser as a foam.

2. The dentifrice according to claim 1 having a viscosity between about 1.1 and 1.6 centiposes.

3. The dentifrice according to claim 1, wherein the non-peroxide disinfecting agent is selected from the group consisting of colloidal silver, honey glucose oxidase, alkali metal antimicrobials, copper bisglycinate, zinc citrate, endoglycosidase, papain, dextranase, mutanase, in an aqueous system, sodium bicarbonate, chlorhexidine, triclosan, triclosan monophosphate and thymol.

4. The dentifrice according to claim 1, wherein the aqueous, non-abrasive composition is in a liquid form within the dispenser.

5. The dentifrice according to claim 1, wherein the aqueous, non-abrasive composition further a foaming agent selected from the group of anionic, nonionic and amphoteric surfactants.

6. The dentifrice according to claim 2, wherein the aqueous, non-abrasive composition further comprises a natural flavoring agent selected from the group consisting of spearmint oil, peppermint oil, menthol, anethole, methyl salicylate, cinnamon oil, clove bud oil, oxanone, and mixtures thereof.

7. The dentifrice according to claim 2, wherein the aqueous, non-abrasive composition further comprises a sweetening agent selected from the group consisting of stevia, sodium saccharin, dextrose, sucrose, chlorinated sucrose, lactose, maltose, aspartame, sodium cyclamate, D-tryptophan, dihydrochalcones, xylitol, and mixtures thereof.

8. The dentifrice according to claim 2, wherein the aqueous, non-abrasive composition further comprises a thickening agent selected from the group consisting of gum karaya, xanthan gum, gum arabic, gum tragacanth and short chain alcohols.

9. The dentifrice according to claim 1, wherein the aqueous, non-abrasive composition further comprises at least one of aloe vera, glycerin, comfry root, calendula, rose hips and pomegranate.

10. A dentifrice composition comprising an aqueous composition having a non-peroxide disinfecting agent, a foaming agent, and a flavoring agent, the aqueous composition having a viscosity suitable to permit the aqueous composition to be dispensed from a propellant-less dispenser as a foam.

11. The dentifrice according to claim 10 wherein the viscosity is between about 1.1 and 1.6 centiposes.

12. The dentifrice according to claim 10, wherein the flavoring agent is selected from the group consisting of peppermint oil, spearmint oil, wintergreen oil, sage oil, parsley oil, mardoram oil, cassia oil, clove bud oil, cinnamon oil, eucalyptus oil, anise oil, and mixtures thereof, limonene, caryophyllene, myrcene, and humulene, menthol, linalool, 3-decanol, pinocarveol, piperitone, menthone, spicatone, 1-carvone, 3-hexanal, n-octanal, menthofuran, pepertione oxide, acetic acid ocenoic acid, dimethyl sulphide, menthyl acetate, benzyl isobutyrate, benzyl-octyl acetate, cinnamic aldehyde, eugenol, ionone, 60 anethole, eucalyptol, methyl salicylate, oxanone, alpha-irisone, vanillin, ethyl vanillin, heliotropine, propenyl guaethol, vanilla extracts, veratraldehyde, 4-cis-heptenal, diacetyl, butyl lactate, ethyl lactate, methyl-para-tert-butyl phenyl acetate, gamma and delta hexalactone, 65 heptalactone, benzodihydropyrone, butter starter distillate, delta tetradecalactone, butyraldehyde, and mixtures thereof.

13. The dentifrice according to claim 10, wherein the aqueous composition is substantially comprised of naturally occurring or naturally derived constituents.

14. The dentifrice according to claim 13, further comprising a fluoride ion source.

15. The dentifrice according to claim 14, further comprising abrasive particulates.

16. The dentifrice according to claim 15, wherein the abrasive particulates are selected from the group of silica or pyrophosphate.
